(19) United States
(12) Patent Application Publication
(10) Pub. No.: US 2013/0219053 A1
(43) Pub. Date: Aug. 22, 2013

(54) METHOD FOR IMPROVED HANDLING OF INCIDENTS IN A NETWORK MONITORING SYSTEM

(71) Applicants: Michael Quade, Meckenheirn (DE); Christof Simon, Bonn (DE); Klaus Kuhn, Bonn (DE)

(72) Inventors: Michael Quade, Meckenheirn (DE); Christof Simon, Bonn (DE); Klaus Kuhn, Bonn (DE)

(73) Assignee: DEUTSCHE TELEKOM AG, Bonn (DE)

(21) Appl. No.: 13/823,896

(22) PCT Filed: Sep. 14, 2011
(86) PCT No.: PCT/EP2011/004604

§ 371 Date: Apr. 18, 2013

(30) Foreign Application Priority Data
Sep. 17, 2010 (EP) 10009830.0

(51) Int. Cl. H04L 12/24

(52) U.S. Cl. CPC H04L 41/0604
USPC 709/224

(57) ABSTRACT

A method for operating a monitored telecommunications network, the telecommunications network management system being monitored by a network management system, the network management system processing alarm messages generated by monitoring components within the telecommunications network, incidents of technical failure or error within the telecommunications network resulting in the generation of the alarm messages by the monitoring components, includes: monitoring the telecommunications network, observed incidents of technical failure or error, and generated alarm messages during a preparatory period of time; determining a scaling parameter per type of alarm message, wherein the scaling parameter is related to the number of incident tickets generated during the preparatory period of time; and suppressing the generated alarm message based on the value of the scaling parameter associated to the type of the generated alarm message.

### CROSS-REFERENCE TO RELATED APPLICATIONS

This application is a U.S. National Phase application under 35 U.S.C. §371 of International Application No. PCT/EP2011/004604, filed on Sep. 14, 2011, and claims benefit to European Patent Application No. EP 10009830.0, filed on Sep. 17, 2010. The International Application was published in English on Mar. 22, 2012 as WO 2012/034684 A1 under PCT Article 21(2).

### FIELD

The invention relates to a method, a system, a program and a computer program product for an improved processing of alarm messages in a monitored telecommunication system.

### BACKGROUND

Maintaining the proper operation of services provided over a network is usually an important but difficult task. Service agents are often called upon to react to a service failure by identifying the problem that caused the failure and then taking steps to correct the problem. The expense of service downtime, the limited supply of network engineers, and the competitive nature of today's marketplace have forced service providers to rely more and more heavily of software tools to keep their networks operating at peak efficiency and to deliver contracted service levels to an expanding customer base. Accordingly, it has become vital that these software tools be able to manage and monitor a network as efficiently as possible. Service agents are, e.g., able to observe desired network events on a real-time basis and respond to them more quickly.

Today, network management systems like Operation and Maintenance Centers (OMCs) are used to maintain the proper operation of a large number of different kinds of network elements and of services provided over the telecommunications networks. For this purpose, the network management systems are arranged to continuously monitor the status, traffic data or the like of the telecommunications network.

Incidents occurring in the telecommunications network result in alarm messages related to said incident which are forwarded to the network management system for further processing. Usually, the processed alarm messages are then passed towards a service agent of the telecommunications network, e.g. by means of a graphical user interface having a display device. The service agent is thus able to analyze the incident based on the displayed alarm message and to generate an incident ticket which will be routed to an incident ticket management system to resolve the incident.

Incidents occurring in modern telecommunications networks typically generate a large number of alarm messages so that analyzing and resolving of incidents is comparably time consuming and labour intensive.

Software tools for network management systems are known from the prior art which allow to manually define a list of alarm types that will be suppressed

### SUMMARY

In an embodiment, the present invention provides a method for operating a monitored telecommunications network. The telecommunications network management system is monitored by a network management system. The network management system processes alarm messages generated by monitoring components within the telecommunications network. Incidents of technical failure or error within the telecommunications network result in the generation of the alarm messages by the monitoring components. Incident tickets are generated in view of the elimination of the incidents of technical failure or error. The method includes: monitoring, by the network management system, the telecommunications network, observed incidents of technical failure or error, and generated alarm messages during a preparatory period of time; determining, regarding different types of the generated alarm messages, a scaling parameter per type of alarm message, wherein the scaling parameter is related to the number of incident tickets generated during the preparatory period of time; and upon generation of an alarm message, suppressing the generated alarm message based on the value of the scaling parameter associated to the type of the generated alarm message. Suppression of the generated alarm message is automatic or based on user input, based on a suppression rule applied within the network management system.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a telecommunications network and a network management system, the telecommunications network comprising at least one radio cell with a User Equipment.

FIG. 2 schematically illustrates a network management system according to the present invention.

### DETAILED DESCRIPTION

Embodiments of the present invention provide a method for a network management system as well as a network management system that allows for a more efficient and more effective manner to handle incidents and related alarm messages, especially by suppressing alarm messages that are related to incidents of minor relevance so that by reducing the overall number of alarm messages to be analyzed by the service agent, the service agent can focus upon incidents of higher relevance either to overall network functionality or to critical parts of the telecommunications network.

In an embodiment, the present invention provides a method for operating a telecommunications network, wherein the telecommunications network is monitored by a network management system, wherein the network management system processes alarm messages generated by monitoring components within the telecommunications network, wherein incidents of technical failure or error within the telecommunications network result in the generation of the alarm messages by the monitoring components, wherein incident tickets are generated in view of the elimination of the incidents of technical failure or error, wherein during a preparatory period of time, a monitoring of
the telecommunications network,
the observed incidents of technical failure or error, and
the generated alarm messages is performed,
   wherein regarding different types of alarm messages, a scaling parameter is determined per type of alarm message, the scaling parameter being related to the number of incident tickets generated during the preparatory period of time, and wherein during operation of the telecommunications network, the method comprises the step of:
upon the generation of an alarm message, suppressing the generated alarm message dependent on the value of the scaling parameter associated to the type of the generated alarm message, wherein the generated alarm message:
is automatically suppressed, or
is suppressed by a user input
   dependent on a suppression rule applied within the network management system.

Thereby, it is advantageously possible to provide a more effective processing of alarm messages for managing the telecommunications network. It is advantageously possible according to the present invention to reduce the number of alarm messages per incident or per incident ticket. By means of the inventive method and by means of the inventive network management system it is possible to suppress certain alarm messages that are related to incidents of minor relevance so that by reducing the overall number of alarm messages to be analyzed by the service agent, the service agent can focus upon incidents of higher relevance either to overall network functionality or to critical parts of the telecommunications network. Thereby, it is possible to resolve the incidents more promptly and assure a better performance of the telecommunications network.

In the context of the present invention, suppressing a generated alarm message means that such a suppressed alarm message is not displayed to a service agent of the network management system. This can be done, e.g., by means of a flag information associated with (or assigned to) the alarm message. Thereby, it is possible to provide different pieces of flag information such as a first flag information, e.g., for indicating a lower level of severity of the alarm message (and the corresponding failures of the telecommunications network), a second flag information, e.g., for indicating an increased level of severity of the alarm message.

According to a preferred first embodiment of the present invention, the scaling parameter depends on the ratio of:
the number of generated incident tickets related to a type of alarm message during the preparatory period of time, and
the number of all alarm messages associated with the type of alarm message during the preparatory period of time.

According to an second preferred embodiment of the present invention, the scaling parameter depends on the ratio of:
the number of all alarm messages related to a type of alarm message during the preparatory period of time and having duration of the alarm of less than or equal to a predetermined time interval, and
the number of all alarm messages related to the type of alarm message during the preparatory period of time.

According to still an alternative third preferred embodiment of the present invention, the scaling parameter depends on whether an incident ticket has been generated related to a type of alarm message during the preparatory period of time.

By means of these different possibilities of determining the scaling parameter, it is possible to provide an effective way of ranking a multitude of different alarm messages such that a more simple and efficient processing of such alarm messages is possible, e.g. by a service agent of the network management system. According to the present invention, it is also possible and preferred:
to use a combination of two different scaling parameters, namely according to the first and second preferred embodiment or according to the first and third preferred embodiment or according to the second and third preferred embodiment; or
to use a combination of three scaling parameters, namely according to the first, second and third preferred embodiments.

Furthermore, it is preferred according to the present invention, that the generated alarm message is suppressed in case that the scaling parameter is smaller than or equal to a predefined threshold value.

According to a further preferred embodiment of the present invention, it is preferred that an individual threshold value is predefined for each type of an alarm message.

According to still a further preferred embodiment of the present invention, it is also preferred that the suppression rule is configured to suppress certain alarm messages entirely but only with respect to a part of the types of alarm message. This means that certain types of alarm messages (out of a multitude of different types of alarm messages) are completely suppressed and other types of alarm messages (out of the multitude of different types of alarm messages) are not suppressed at all (i.e. none of these alarm messages (being of that other types of alarm messages) are suppressed).

The suppression of alarm messages is governed by a suppression rule or by a plurality of suppression rules. Examples of such suppression rules comprise:

In case that, during the preparatory period,
a plurality of alarm messages are generated following an incident of technical failure or error within the telecommunications network, and
a first subset of these alarm messages are associated with one incident ticket or a plurality of incident tickets, whereas a second subset of these alarm messages are not associated with one incident ticket or a plurality of incident tickets,
   then a first scaling parameter, relating to the first subset of alarm messages, is modified, e.g. increased, and a second scaling parameter, relating to the second subset of alarm messages, is modified differently, e.g. reduced, such that the second subset of alarm messages are automatically suppressed by the application of a suppression rule of the form that alarm messages are suppressed in case that the corresponding scaling parameter is below a certain threshold.
   According to an alternative example of a suppression rule, in case that, during the preparatory period,
a modification of the first scaling parameter, relating to the first subset of alarm messages, is modified, e.g. increased, only in case that an incident ticket is repeatedly associated to the first subset of alarm messages, and
a modification of the second scaling parameter, relating to the second subset of alarm messages, is modified differently, e.g. reduced, only in case that an incident ticket is repeatedly not associated to the second subset of alarm messages,
   and the second subset of alarm messages being automatically suppressed by the application of a suppression rule of the form that alarm messages are suppressed in case that the corresponding scaling parameter is below a certain threshold.

Furthermore, it is preferred according to the present invention to perform the suppression of alarm messages depending on the time of the day, i.e. that a first set of suppression rules apply, e.g., during daytime hours (e.g. from 6 a.m. to 6 p.m.), and a second set of suppression rules apply, e.g., during night-time hours (e.g. from 6 p.m. to 6 a.m.). This means that it is preferred according to the present invention
to base the determination or modification of scaling parameters, and hence the determination of suppression rules, to be applied for daytime hours on the treatment of alarm messages and incident tickets during daytime hours, and, likewise,

to base the determination or modification of scaling parameters, and hence the determination of suppression rules, to be applied for night-time hours on the treatment of alarm messages and incident tickets during night-time hours.

Furthermore, it is preferred according to the present invention to perform the suppression of alarm messages depending on the day of the week, i.e. that a third set of suppression rules apply, e.g., during working days (e.g. from Monday to Friday), and a fourth set of suppression rules apply, e.g., during weekends (e.g. on Saturdays and Sundays). This means that it is preferred according to the present invention
to base the determination or modification of scaling parameters, and hence the determination of suppression rules, to be applied for working days on the treatment of alarm messages and incident tickets) during working days, and, likewise,
to base the determination or modification of scaling parameters, and hence the determination of suppression rules, to be applied for weekends on the treatment of incidents or errors of the telecommunications network (i.e. the treatment of alarm messages and incident tickets) during weekends.
   Furthermore, it is preferred according to the present invention to perform the suppression of alarm messages depending on the group of agents or operators, i.e. that a fifth set of suppression rules apply, e.g., for a first team of agents or operators, and a sixth set of suppression rules apply, e.g., for a second team of agents or operators. This means that it is preferred according to the present invention
to base the determination or modification of scaling parameters, and hence the determination of suppression rules, to be applied for the first team of agents or operators on the treatment of incidents or errors of the telecommunications network (i.e. the treatment of alarm messages and incident tickets) of the first team of agents or operators, and, likewise,
to base the determination or modification of scaling parameters, and hence the determination of suppression rules, to be applied for the second team of agents or operators on the treatment of incidents or errors of the telecommunications network (i.e. the treatment of alarm messages and incident tickets) of the second team of agents or operators.

In a further embodiment, a network management system is provided for operating a telecommunications network, wherein the network management system processes alarm messages generated by monitoring components within the telecommunications network, wherein incidents of technical failure or error within the telecommunications network result in the generation of the alarm messages by the monitoring components, wherein the network management system is configured such that incident tickets are generated in view of the elimination of the incidents of technical failure or error, wherein the network management system is provided such that during a preparatory period of time, a monitoring of
the telecommunications network,
the observed incidents of technical failure or error, and
the generated alarm messages
   is performed, wherein regarding different types of alarm messages, a scaling parameter is determined per type of alarm message, the scaling parameter being related to the number of incident tickets generated during the preparatory period of time, and wherein the network management system is provided such that during operation of the telecommunications network, upon the generation of a new alarm message, the generated alarm message is suppressed dependent on the value of the scaling parameter associated to the type of the generated alarm message.

Thereby, it is advantageously possible to suppress certain alarm messages that are related to incidents of minor relevance so that the incidents within the telecommunications network can be resolved more promptly and a better network performance be assured.

It is preferred according to the present invention that the network management system comprises a first database for storing first data related to alarm messages generated during the preparatory period of time, wherein the first data are categorized into alarm types, wherein the network management system comprises a second database for storing second data related to incident tickets generated during the preparatory period of time, wherein scaling parameter is generated dependent on the first and second data.

Additionally, the present invention relates to a program comprising a computer readable program code for executing an inventive method or for configuring or controlling an inventive network management system.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

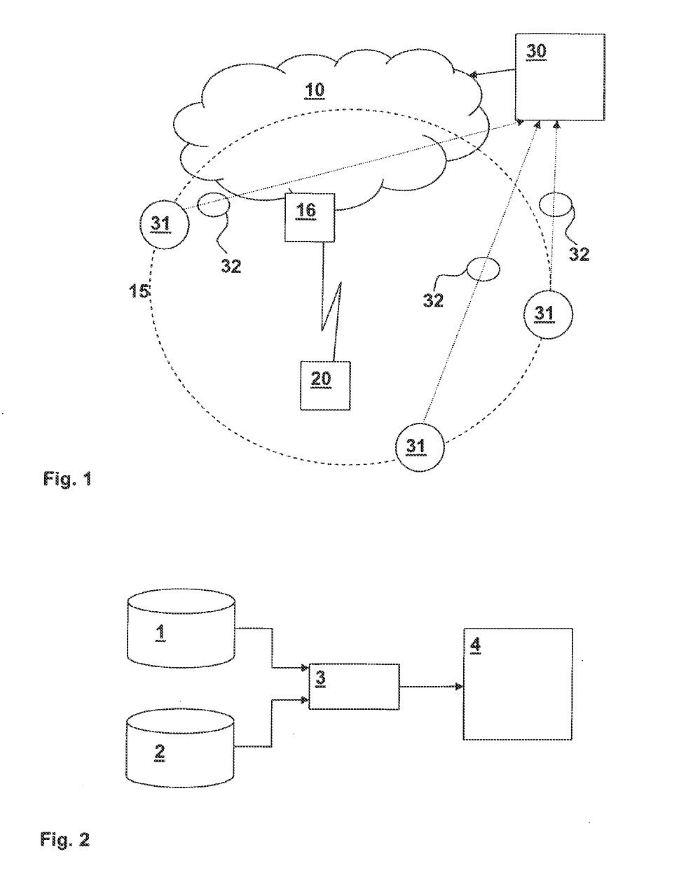

In FIG. 1, a telecommunications network 10, e.g. a cellular public land mobile network 10, and a network management system 30 is schematically shown, wherein the telecommunications network 10 (in the exemplary form of a public land mobile network 10) comprises at least one radio cell with a User Equipment. Such a public land mobile network 10 comprises a plurality of cells, one of which is represented by means of a dashed circle and designated by reference sign 15. The cell 15 also comprises a base station 16 (i.e. a fixed device such as an eNodeB or the like) having at least one antenna such that radio coverage within the cell 15 is provided. Within the coverage area of the cell 15, a User Equipment 20 is schematically illustrated. Usually, a cell 15 comprises a plurality of identical or different User Equipments such as the User Equipment 20.

Furthermore, a network management system 30 is provided for managing the telecommunications network 10 and for maintaining the telecommunications network 30 in an operational state. To this end, a plurality of monitoring components 31 are provided within the telecommunications network 10. Such monitoring components 31 can be provided as part of one or a plurality of network elements or network entities of the telecommunications network 10. Alternatively, such monitoring components 31 can be provided independently of a network entity or network element. The monitoring components 31 serve as indicators or sensors of incidents within the telecommunications network 10. An incident is related to a condition of failure or a condition of error of a certain functionality of the telecommunications network 10 or of one of its components or elements. In case that one of the monitoring components 31 detects an incident, an alarm message is generated by the monitoring component 31 or by an associated device or software module, and the alarm message transmitted to the network management system 30. In FIG. 1, this is represented by means of dotted lines or arrows between the monitoring components 31 and the network management system 30.

With the network management system 30 according to the present invention and with the inventive method for operating a telecommunications network 10, it is possible to automatically analyze the alarm messages in view of a more effective and more efficient processing of these alarm messages. This is possible by detecting such alarm messages 32 that are of less importance because:
they relate to a type of alarm message having less probability of being associated with an incident ticket or because
they relate to a type of alarm message having only a comparably short duration or being associated only to a predetermined time interval being a relatively short interval of time, e.g. less than or equal to five minutes, or less then or equal to ten minutes or less then or equal to two minutes.
   Alarm messages 32 that are generated (hereinafter also called “generated alarm messages 32”) and that correspond to a type of alarm messages that has been found (by evaluating alarm messages of a previous interval of time, hereinafter also called preparatory period of time) to have a comparably small probability of being associated with an incident ticket and/or that has been found to have normally only a comparably short duration, are suppressed according to the present invention.

According to the present invention, a scaling parameter is computed, based on an evaluation of alarm messages 32 during the preparatory period of time. The scaling parameter is determined per type of alarm message, e.g. relating to the priority of the alarm message, or relating to which kind of technical equipment is concerned, or relating to the impact of the alarm message on the functionality of the telecommunications network, or relating to the impact of the alarm message (or incident) on downstream systems or components.

In FIG. 2, a network management system 30 according to the present invention is schematically shown. A first database 1 comprises first data related to alarm messages 32 generated during the preparatory period of time, the first data being categorized into different types of alarm messages. Furthermore, the network management system 30 comprises a second database 2 for storing second data related to incident tickets generated during the preparatory period of time. In a computing entity 3, the scaling parameter associated with a newly generated alarm message 32 (based on the type of the alarm message) is computed and —based on the application of suppression rules stored within the network management system 30—decided whether the newly generated alarm message is to be displayed in a display system 4 of the network management system 30 or not (or only on service agent request or the like).

It is preferred that the scaling parameter depends on the ratio of:
the number of generated incident tickets related to a type of alarm message 32 during the preparatory period of time, and
the number of all alarm messages 32 associated with the type of alarm message 32 during the preparatory period of time.
   Furthermore, it is preferred that the scaling parameter depends on the ratio of:
the number of all alarm messages 32 related to a type of alarm message during the preparatory period of time and having duration of the alarm of less than 5 minutes, and
the number of all alarm messages 32 related to the type of alarm message during the preparatory period of time.
   Furthermore, it is preferred that the scaling parameter depends on whether an incident ticket has been generated related to a type of alarm message 32 during the preparatory period of time.

Thereby, it is possible to achieve the aim that service agents within the network management system 30 are not disturbed by generated alarm messages 32 of minor importance or by generated alarm messages 32 having only a comparably short duration. Thereby, the efficiency of the processing of the alarm messages 32 can be enhanced. According to the present invention, it is furthermore advantageous that the inventive method and network management system is able to provide a suppression of alarm messages without the need for a complex configuration and the establishment of correlation rules between different types of alarm messages.

According to a first embodiment of the present invention, an evaluation of alarm messages is performed during a preparatory period of time (which can be cyclically repeated), wherein the evaluation comprises a counting for each type of alarm messages of such alarm messages (of that type of alarm messages) that are associated with an incident ticket and such alarm messages (of that type of alarm messages) that are not associated with an incident ticket. Depending on the ratio of the number of alarm messages associated with an incident ticket and the total number of alarm messages (of that type of alarm messages), the scaling parameter is computed. Preferably, the scaling parameter corresponds to that ratio, i.e. the scaling parameter is the probability (at least based on the evaluation during the preparatory period of time) of an alarm message of that specific type of alarm messages having an incident ticket generated. Based on the scaling parameter, a generated alarm message can be suppressed in the further processing within the network management system 30. For example, this is possible by defining certain threshold values for the scaling parameter (corresponding to that specific type of alarm messages). According to the present invention, suppressing rules are defined such that in case the scaling parameter is below a certain threshold, then the generated alarm message will be suppressed or associated to a lower prioritized category of alarm messages 32.

According to the present invention, the suppression of alarm messages can be interrupted such that critical alarm messages 32 will be displayed.

The preparatory period of time according to the present invention can correspond, e.g., to the previous day or a certain number of previous days or the previous month or a number of previous months. It is possible that the preparatory period of time is a moving time window of a certain duration preceding the time of operation of the network management system 30.

Furthermore, it is possible and preferred according to the present invention that the suppression of generated alarm messages can be activated or not per type of alarm message, i.e. depending on the type of alarm message.

According to the present invention, the following exemplary method for operating the monitored telecommunications network 10 by an adaptive network management system 30 is possible, wherein the following steps occur during the preparatory period of time which is defined according to the present invention as being, e.g. one day, or one week or one month or a plurality of days (such as two or three or four days) or a plurality of weeks (such as two or three or four weeks) or a plurality of months (such as two or three or four months): At a first point in time, an incident occurs within the telecommunications network 10. Thereby, a certain number of alarm messages 32 are generated, and, e.g., by different entities of the telecommunications network 10. For example, ten different alarm messages 32 are generated.

The generated alarm messages 32 are transmitted to the network management system 30. At a second point in time, an incident agent generates an incident ticket relating to the occurred incident. Out of the generated alarm messages (in the example the ten alarm messages related to the occurred incident), the incident agent associates or assigns a certain number, e.g. five alarm messages, to the generated incident ticket; these assigned alarm messages are also called a first subset of these alarm messages, whereas the non-assigned alarm messages are called a second subset of alarm messages.
During the preparatory period, a plurality of (e.g. comparable) incidents occur, e.g. eight incidents, and for each of these incidents,
a certain number of alarm messages 32 are generated (e.g. ten alarm messages),
an incident ticket is generated, and
the incident ticket is assigned or associated to a part of the generated alarm messages 32 (e.g. to five alarm messages) which are called the first subset of alarm messages (and a second subset of alarm messages are not assigned to the incident ticket).
   After the termination of the preparatory period, and for each occurrence of the incidents, there exist the first subset of alarm messages 32 and the second subset of alarm messages. Based on the resulting groups of first subsets of alarm messages 32 and of second subsets of alarm messages, it is possible according to the present invention to suppress certain alarm messages at further occurrences of incidents (especially incidents comparable to the incidents monitored or tracked during the preparatory period of time).
   For example, a suppression rule is established such that alarm messages that have often been part of the second subset of alarm messages (i.e. that have not been associated with the incident ticket) are suppressed during the normal execution of the inventive method (i.e. not during the preparatory period). For example, if, for a certain type of alarm message (e.g. generated by a specific network element of the telecommunications network 10), the ratio of
the number of incidents where this type of alarm message is not associated to the incident ticket (i.e. the alarm message belongs to the second subset of alarm messages for that incident) compared to
the total number of such a type of alarm messages
   is elevated by too much, e.g. higher than 1% or 5%, then such a type of alarm message is suppressed.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1-11. (canceled)

12. A method for operating a monitored telecommunications network, wherein the telecommunications network management system is monitored by a network management system, and the network management system processes alarm messages generated by monitoring components within the telecommunications network, wherein incidents of technical failure or error within the telecommunications network result in the generation of the alarm messages by the monitoring components, wherein incident tickets are generated in view of the elimination of the incidents of technical failure or error, the method comprising:
monitoring, by the network management system, the telecommunications network, observed incidents of technical failure or error, and generated alarm messages during a preparatory period of time;
determining, regarding different types of the generated alarm messages, a scaling parameter per type of alarm message, wherein the scaling parameter is related to the number of incident tickets generated during the preparatory period of time; and
upon generation of an alarm message, suppressing the generated alarm message based on the value of the scaling parameter associated to the type of the generated alarm message;
wherein, suppression of the generated alarm message is automatic or based on user input, based on a suppression rule applied within the network management system.

13. The method according to claim 12, wherein the scaling parameter is based on the ratio of:
the number of generated incident tickets related to a type of alarm message during the preparatory period of time; and
the number of all alarm messages associated with the type of alarm message during the preparatory period of time.

14. The method according to claim 12, wherein the scaling parameter is based on the ratio of:
the number of all alarm messages related to a type of alarm message during the preparatory period of time and having duration of the alarm of less than or equal to a predetermined time interval, and
the number of all alarm messages related to the type of alarm message during the preparatory period of time.

15. The method according to claim 12, wherein the scaling parameter depends on whether an incident ticket has been generated related to a type of alarm message during the preparatory period of time.

16. The method according to claim 12, wherein the generated alarm message is suppressed in case that the scaling parameter is smaller than or equal to a predefined threshold value.

17. The method according to claim 16, wherein an individual threshold value is predefined for each type of an alarm message.

18. The method according to claim 12, wherein the suppression rule is configured to suppress certain alarm messages entirely with respect to a part of the types of alarm messages.

19. A network management system for operating a monitored telecommunications network, the network management system being configured to process alarm messages generated by monitoring components within the telecommunications network, wherein incidents of technical failure or error within the telecommunications network result in the generation of the alarm messages by the monitoring components, and wherein the network management system is configured such that incident tickets are generated in view of the elimination of the incidents of technical failure or error, the network management system being further configured to:
monitor the telecommunications network, the observed incidents of technical failure or error, and the generated alarm messages during a preparatory period of time;
regarding different types of alarm messages, determine a scaling parameter per type of alarm message, the scaling parameter being, related to the number of incident tickets generated during the preparatory period of time; and
upon the generation of a new alarm message, suppress the generated alarm message based on the value of the scaling parameter associated to the type of the generated alarm message.

20. The network management system according to claim 19, wherein the network management system comprises:
a first database for storing first data related to alarm messages generated during the preparatory period of time, wherein the first data are categorized into different types of alarm messages; and
a second database for storing second data related to incident tickets generated during the preparatory period of time;
wherein the scaling parameter is determined based on the first and second data.

21. The network management system according to claim 19, wherein the telecommunications network is a Public Land Mobile Network.

22. A non-transitory computer-readable medium, part of a network management system, having computer-executable instructions stored thereon, for operating a monitored telecommunications network, the network management system being configured to process alarm messages generated by monitoring components within the telecommunications network, wherein incidents of technical failure or error within the telecommunications network result in the generation of the alarm messages by the monitoring components, and wherein the network management system is configured such that incident tickets are generated in view of the elimination of the incidents of technical failure or error, the computer-executable instructions, when executed by a processor, causing the following steps to be performed:
monitoring the telecommunications network, the observed incidents of technical failure or error, and the generated alarm messages during a preparatory period of time;
regarding different types of alarm messages, determining a scaling parameter per type of alarm message, the scaling parameter being related to the number of incident tickets generated during the preparatory period of time; and
upon the generation of a new alarm message, suppressing the generated alarm message based on the value of the scaling parameter associated to the type of the generated alarm message.
